(19) United States
(12) Patent Application Publication
(10) Pub. No.: US 2025/0112322 A1
(43) Pub. Date: Apr. 3, 2025

(54) DISC-SHAPED SECONDARY BATTERY WITH MULTI-CONTACT ELECTRODE ASSEMBLY, CAN, AND CAP

(71) Applicant: Ian Dean Hosein, Minoa, NY (US)

(72) Inventor: Ian Dean Hosein, Minoa, NY (US)

(73) Assignee: Syracuse University, Syracuse, NY (US)

(21) Appl. No.: 18/900,212

(22) Filed: Sep. 27, 2024

Related U.S. Application Data
(60) Provisional application No. 63/541,496, filed on Sep. 29, 2023.

(51) Int. Cl. H01M 50/342; H01M 10/0587; H01M 50/109; H01M 50/153; H01M 50/186; H01M 50/578; H01M 50/581

(52) U.S. Cl. CPC H01M 50/3425; H01M 10/0587; H01M 50/109; H01M 50/153; H01M 50/186; H01M 50/578; H01M 50/581; H01M 2200/106; H01M 2200/20

(57) ABSTRACT

A secondary battery having an electrode assembly including a positive electrode plate, a negative electrode plate, and a separator interposed between the electrode plates, wherein the electrode plates are disposed in a rolled spiral configuration. A can is sized to house the electrode assembly and a cap assembly, which includes a vent plate having a plurality of deformable sections and one or more electric connection portions disposed between the deformable sections that are radially disposed and fixedly secured to an electrode assembly. When an internal pressure of the secondary battery is greater than a predetermined level, the deformable sections upwardly deform to drive the electric connection portions into contact with one or more multiple points of a current interrupt device (CID). The secondary battery has a low aspect ratio as compared to cylindrical cells with an overall height dimension that is smaller than a corresponding width dimension.

### CROSS REFERENCE TO RELATED APPLICATION

This application claims priority to U.S. Patent Application Ser. No. 63/541,496, filed Sep. 29, 2023, under relevant portions of 35 U.S.C. §§ 119 and 120, the entire contents of which is herein incorporated by reference.

### TECHNICAL FIELD

The application is generally directed to the field of energy storage and more specifically to a secondary battery having an electrode assembly, can assembly and cover, including multiple electrode tabs integrated into the electrode assembly. Additionally, the can assembly features multiple points of contact provided by a specialized vent plate, and in which the vent plate is positionally aligned with a current interrupt device (CID). This configuration enhances the overall stability and performance of the secondary battery.

### BACKGROUND

Secondary batteries have become ubiquitous in a wide range of electronic applications, spanning from portable devices such as cellphones and computers to the ever-growing electric vehicle market. As the demand for portable and renewable energy solutions continues to surge, the development of secondary batteries has remained a focal point in the pursuit of higher capacity and energy density.

High-capacity batteries, including battery packs with multiple interconnected battery cells, have found widespread use as power supplies for hybrid vehicles and various other applications. Among these, lithium secondary batteries stand out due to their higher operating voltage (3.6V) and superior energy density per unit weight, as compared to conventional nickel-cadmium batteries, nickel-metal hydride batteries, and similar alternatives.

The prominence of electric vehicles in the market is rapidly increasing, driving the necessity for the development of advanced battery assemblies and battery packs that can offer increased energy density while reducing overall size and weight. Additionally, managing high electricity delivery and heat dissipation has become a crucial focus to ensure the optimal performance and safety of these batteries in electric vehicles.

The ongoing progress in battery technology aims to efficiently pack cells in battery packs, maintaining a low volumetric footprint, and minimizing size and weight. These efforts are crucial to achieve enhanced current delivery efficiency and effective thermal management, both of which are vital factors in ensuring the batteries' longevity and overall performance.

Lithium secondary batteries can be categorized based on their housing shape, namely can-type lithium secondary batteries or pouch-type lithium secondary batteries. Can-type batteries, in turn, come in two (2) varieties: prismatic lithium secondary batteries and cylinder-type lithium secondary batteries. Furthermore, lithium secondary batteries are further differentiated by their electrolyte type, leading to two (2) main types, namely, lithium-ion secondary batteries and lithium-polymer secondary batteries.

Cylindrical can-type secondary batteries present several challenges that need to be addressed. One major challenge is the generation of heat during operation, which can lead to the cell rupturing due to off-gassing from evaporating electrolyte. Additionally, the use of only one electrode tap on both positive and negative terminals puts significant stress on the battery, as all of the electrical current is forced to pass through these two tabs. Moreover, the standard cylindrical battery cells (18 mm diameter, 650 mm in height) commonly used in large-scale applications, such as electric vehicles, were originally intended for small electronic devices. Therefore, there is a pressing need for a battery can assembly design that allows for efficient battery packing in battery packs, that improves heat dissipation, and which enables high current delivery to meet the demands of modern applications.

To address the above-mentioned issues, the cylinder-type lithium secondary battery employs a cap assembly that acts as a safeguard when the internal pressure exceeds a set threshold, due to overcharging or abnormal operation. The cap assembly intervenes in the battery's current flow, preventing further temperature rise and enhancing the overall stability of the battery.

This cylinder-type secondary battery is composed of a can, to which a cap assembly is attached via an insulating gasket at the upper opening. The can houses an electrode assembly and an electrolyte in addition to the cap assembly. The electrode assembly comprises two rectangular plate-shaped electrodes separated by a separator to avoid any short circuits. These components are then wound together spirally in a jelly roll-type shape.

By implementing this design, the cylinder-type secondary battery can effectively mitigate safety concerns related to pressure buildup, ensuring a more stable and reliable operation under various conditions.

A conventional cap assembly consists of a vent, a current interrupt device (CID), a positive temperature coefficient (PTC) thermistor, and a cap-up, each of which are sequentially stacked. In the conventional cap assembly, and when the internal pressure of the secondary battery exceeds a predetermined level, the vent deforms, triggering the CID to interrupt the flow of current and release gas generated by the electrode assembly to the exterior.

However, conventional cap assemblies exhibit limitations in their design. For example, these assemblies typically provide only a single electrode tab that is connected to the electrode assembly, leading to a single point of current collection on either the positive or negative terminals of the battery. Additionally, the cylindrical shape of the battery hampers optimal heat dissipation. Moreover, having a single vent electrical contact to the top electrode tab results in a singular point of high current and pressure detection and shutdown during instances of over-charging, over-discharging, and abnormal operation, contributing to increased heat generation, solvent evaporation, and potential instability, particularly at high currents for both charging and discharging.

Consequently, ensuring battery stability, especially under high-demand conditions, becomes challenging due to the overall cylindrical shape of the batteries and the limitations of the current CID activation and vent design. On the contrary, if there were multiple points of contact to the electrode assembly of the battery, it could potentially continue functioning instead of being discarded when the vent deforms to activate the CID. Additionally, a shape that promotes efficient heat dissipation would enhance the battery's stability during high-demand use. These concerns not only raise uncertainties about battery stability but also give rise to waste and viability issues in using current cylindrical cells for high-demand applications like large-scale stationary storage or electric vehicles. Addressing these limitations is crucial to enhancing the performance and safety of cylindrical secondary batteries and paving the way for their successful implementation in diverse high-demand scenarios.

### BRIEF DESCRIPTION

Therefore and according to at least one aspect of the present invention, there is provided a secondary battery comprising an electrode assembly including a positive electrode plate, a negative electrode plate, and a separator interposed between the positive and negative electrode plates, each of the electrode plates being disposed in a rolled spiral configuration. A can is sized and configured to house the electrode assembly; wherein the secondary battery further comprises a cap assembly disposed above the electrode assembly within the can. The cap assembly comprises a vent plate configured to seal an opening of the can, wherein the vent plate includes a plurality of deformable sections and one or more electric connection portions, the secondary battery having an overall height dimension that is smaller than a corresponding width dimension.

In at least one version, the can assembly of the secondary battery further comprises a current interrupt device (CID) having a plurality of contacts disposed along the span of the CID, each of the plurality of contacts being aligned with the one or more electric connection portions of the vent plate. In at least one embodiment, the electric connections of the vent plate comprise protrusions that are sized and configured for engaging one or more of the contacts of the CID when internal pressure in the battery exceeds a threshold.

In at least one embodiment, the electrode assembly includes a plurality of electrode tabs extending from the top of the formed spiral configuration, in which each of the plurality of electrode tabs are fixedly engaged with an electric connection of the vent plate. The electrode assembly can further include a plurality of electrode tabs extending from the bottom of the electrode assembly. According to at least one embodiment, the bottom electrode tabs are joined to one another and to a bottom of the can.

In accordance with other aspects of the present invention, there is provided a cap assembly for a secondary battery, the cap assembly comprising a vent plate having a plurality of deformable sections and a plurality of electric connection portions, each electric connection portion being disposed between a pair of the deformable sections, the vent plate being configured for movement between a first position and a second position depending on an internal pressure of the secondary battery.

According to at least one other version, there is provided a cap assembly configured to seal a secondary battery, the cap assembly comprising a vent plate comprising multiple deformable portions and a plurality of electric connection portions. Each electric connection portion comprises a raised protrusion on an upper facing side and a notch on a lower facing side, each of the electric connection portions being disposed between a pair of downwardly extending deformable portions. The cap assembly further comprises a current interrupt device (CID) having multiple contact points, the CID being positioned directly over the vent plate, a positive temperature coefficient (PTC) thermistor placed on the CID; and a cap-up having a plurality of vent holes located on the PTC thermistor. The protrusions are configured to contact one or more of the multiple contact points of the CID when one or more of the deformable portions are deformed due to an increase in internal pressure in the secondary battery.

The invention further features, according to at some aspects, an electrode assembly for a secondary battery having a low aspect ratio in which the height dimension of the secondary battery is smaller than a corresponding width dimension, the electrode assembly comprising a positive electrode plate, a negative electrode plate, each of the positive and negative electrode plates being configured in a rolled spiral configuration; and a plurality of electrical tabs formed on and extending from a top and bottom of the positive and negative electrodes to respective top and bottom contacts of the battery assembly. In a preferred embodiment, the electric connection portions of the vent plate are fixedly attached to electrode tabs at the top of the electrode assembly.

In the present invention and owing to the wider area of the battery, the cap-up (i.e., top external contact) of the battery is designed with several vent holes disposed in a spaced relation, preferably in a circular pattern. This design serves two essential purposes: first, this design enhances the mechanical strength of the cap-up, and second, the design of the cap-up facilitates improved thermal dissipation from the battery, contributing to its overall stability and performance. The vent holes according to at least one embodiment can be hexagonal in shape.

According to aspects of the invention, the electric connection portions of the vent plate can be formed at various locations along a radius of the vent plate, which is preferably disc-shaped. The protrusions, which may be formed between a pair of deformable portions of the vent plate are positioned and configured to engage one or more corresponding points of contact of the CID, for activating same when the vent plate is moved from the first position to the second position.

In accordance with various aspects of the present invention, the protrusions for activating the CID are positioned at both the central portion, as well as along the radius of the vent plate. The number and distribution of the protrusions, in turn, enhances stability by enabling multiple points of activation upon the vent plate at different locations of the CID, which preferably includes multiple points of activation along its span. These multiple points of activation can be situated both at the center and along the span of the CID, extending towards an outer edge of the aligned vent plate. This design ensures that pressure is uniformly applied to the entire area of the vent plate, resulting in uniform deformation and improved distribution of activation pressures.

Regarding the electrode assembly, aspects of the present invention incorporate multiple electrode tabs, thereby adequately linking the terminal at the top and the terminal at the bottom of the battery assembly. A plurality of electrode tabs at the top of the electrode assembly can be aligned for connection with notches or other features formed on each of the electric connection portions of the vent plate. The plurality of electrode tabs at the bottom of the electrode assembly are preferably connected to the bottom of the battery can. According to at least one embodiment, the bottom electrode tabs can be commonly linked to one another following bending of the tabs, preferably toward the center of the electrode assembly.

According to at least one version, the top and bottom electrode tabs may be positioned at various points along the span of the electrode assembly. In one preferred version, the tabs can be disposed along a line extending through the center of the electrode assembly.

The herein described secondary battery and sub-assemblies offer several advantages over present battery technologies as a storage solution. First and by providing multiple electrode tabs for the positive and negative terminals, more uniform current distribution is ensured with reduced electrical stress on the battery, thereby further resulting in enhanced stability of the battery, particularly during high-demand use. Accordingly, there is considerably less risk of cell rupture, which improves overall safety.

Additionally, the low aspect ratio of the inventive battery, including the cap assembly design and multi-contact vent plate, promotes efficient heat dissipation. Heat generation during charging and discharging is mitigated, thereby increasing the service life of the battery and improving overall reliability, which is a critical aspect in electric vehicles and other high-demand applications.

Still further, the multi-contact electrode assembly with increased points of contact (i.e., tabs) improves energy density, allowing for more energy storage within the same footprint. This increase in storage also leads to improved battery life and extended operating time for portable electronic devices and electric vehicles.

The multi-contact vent plate of the secondary battery, including the disposed electric connection portions, offers multiple points of activation for the current interrupt device (CID). This design ensures uniform pressure distribution during gas release and activation, reducing the risk of deformations and leakage caused by charging and discharging and providing additional safety measures.

The flexible battery design of the present invention is scalable and offers versatility and adaptability for a myriad of diverse applications and uses ranging from small portable electronics to large-scale stationary energy storage systems. Moreover and by addressing the limitations of single cylindrical cells, which include single point activation and limited heat dissipation, the herein described battery design potentially reduces battery waste and enhances the viability of existing cylindrical cells and high-demand solutions. The environmentally friendly approach of the herein described battery design aligns well with the global push for sustainable energy storage solutions.

The herein described battery provides use in literally any industry including but not limited to aerospace, medical devices and uninterrupted power supplies (UPS), addressing various needs of these industries, and thereby advancing energy storage technology.

The resulting effects of the herein described battery design can lead to breakthroughs in energy storage technology. For example, the improved battery design, enhanced stability and improved heat dissipation of the design can lead to the development efficient and reliable battery packs for electric vehicles. That is, the use of low aspect ratio batteries in lieu of conventional cylindrical cells with multi-contact points of activation could enhance energy density, improve thermal management, and allow for higher current delivery, thereby addressing some of the key challenges faced by current electric vehicle technology.

The herein described battery design is arguably more reliable for powering portable electronic devices such as but not limited to smartphones, laptops and tablets. The low aspect ratio design of the batteries can be easily integrated into the slim and compact form factors of these devices, providing longer battery life and better overall performance.

As the world transitions to a greener and more sustainable energy infrastructure, the demand for efficient energy storage solutions increases. The improved stability, safety features, and higher energy density offered by the present invention provides a viable option for storing renewable energy generated from solar and wind sources.

Beyond portable applications, the enhanced stability and heat dissipation characteristics of the herein described battery design creates opportunities for large-scale stationary energy storage systems. For example, batteries made in accordance with the inventive design could be deployed to store excess energy generated by power plants during low-demand periods and release the energy during peak-demand times, thereby stabilizing the grid and improve overall energy efficiency. Moreover, the space and weight savings provided by the batteries can be crucial, for example, in the aerospace industry in satellites and other vehicles, while still ensuring a safe and efficient power supply, in the demanding conditions found in space and aviation related applications.

The stability and safety features further provide suitability in uninterruptible power supplies (UPS) and related systems that provide backup power during blackouts or power grid failures. These batteries can ensure uninterrupted power supply to critical infrastructure, data centers, and emergency services. Still further, the uniquely compact design of the herein described battery as well as improved thermal management and high energy density is highly advantageous for medical devices and wearable healthcare technology. The herein described batteries can power a range of medical devices, including pacemakers, infusion pumps, as well as monitoring devices, offering longer operational life and improved patient care. Accordingly, the present design provides a limitless number of existing and evolving industries, applications and uses for advanced and efficient battery technology.

The low aspect ratio of the herein described secondary battery, including the disc or similar shape of the secondary battery, enhances heat dissipation, further contributing to battery stability during high-demand use. Accordingly, the present invention successfully addresses a number of issues or challenges found in conventional cylindrical batteries, making the herein described battery viable for applications such as electric vehicles (EVs), as well as large-scale stationary power storage systems.

Overall, the herein described secondary battery represents a significant advance in battery technology given the design of the vent plate, electrode assembly, offering a safe and efficient energy storage solution as the world seeks sustainable and eco-friendly energy sources.

The innovative design of a disc or similarly shaped battery having a low aspect ratio, as described herein, is further proposed to enable the total cell count in a battery pack, such as those used in electric vehicles and other applications, to be significantly reduced. Conventional electric vehicles currently rely upon thousands of cylindrical cells for power storage. The unique shape and form factor of the inventive battery, however, creates volumetric growth, which follows the square of the radius of the disc-shape. This characteristic translates to a more rapid increase in energy density when compared to traditional cylindrical cells, and whose improvements typically involve height adjustments, e.g., the transition from 18650 to 21700. Consequently, an implementation of the herein described design naturally leads to an advantageous reduction in the quantity of cells required in the battery pack. This reduction provides substantial benefits, notably by diminishing the overall count of interconnections, cooling modules, electrical circuitry and associated components.

These and other features and advantages will be readily apparent from the following Detailed Description, which should be read in conjunction with the accompanying drawings.

### BRIEF DESCRIPTION OF THE DRAWINGS

FIG. 1 shows a side elevational view, at least partially in section, of a secondary battery cell made in accordance with various aspects of the present invention, including a can, battery electrode assembly, cap assembly and cap-up;

FIG. 2 provides an exploded assembly view of the different components of the cap assembly and battery electrode assembly in accordance with aspects of the invention;

FIG. 3(A) is a top perspective view of a multiple-point contact vent plate made in accordance with aspects of the present invention;

FIG. 3(B) is a side elevational view of the multiple-point contact vent plate of FIG. 3(A);

FIG. 4(A) is a top plan view of an exemplary multiple-point contact current interrupt device (CID) made in accordance with aspects of the present invention; and

FIG. 4(B) is a top perspective view of the CID of FIG. 4(A).

### DETAILED DESCRIPTION

We herein refer to an exemplary embodiment of the present invention, as illustrated in the accompanying drawings. Throughout the description, similar reference numerals will be used for corresponding elements. The exemplary embodiments serve to explain the various aspects of the present invention with reference to the figures. When we mention that a first element is disposed “on” or adjacent to a second element, it means the first element can directly contact the second element or have one or more other elements between them. In contrast, if an element is referred to as being disposed “directly on” another element, there are no intervening elements present. Additionally, the term “and/or” includes any combination of one or more of the listed items.

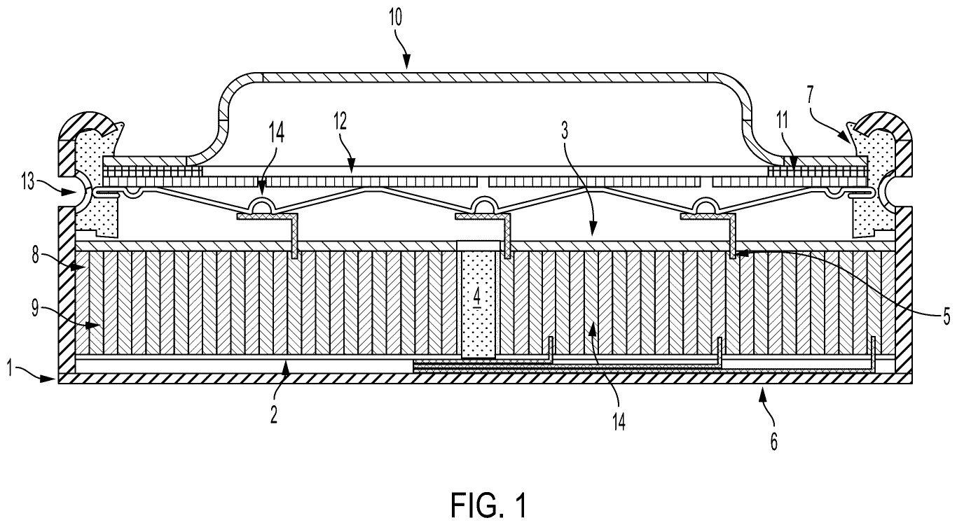

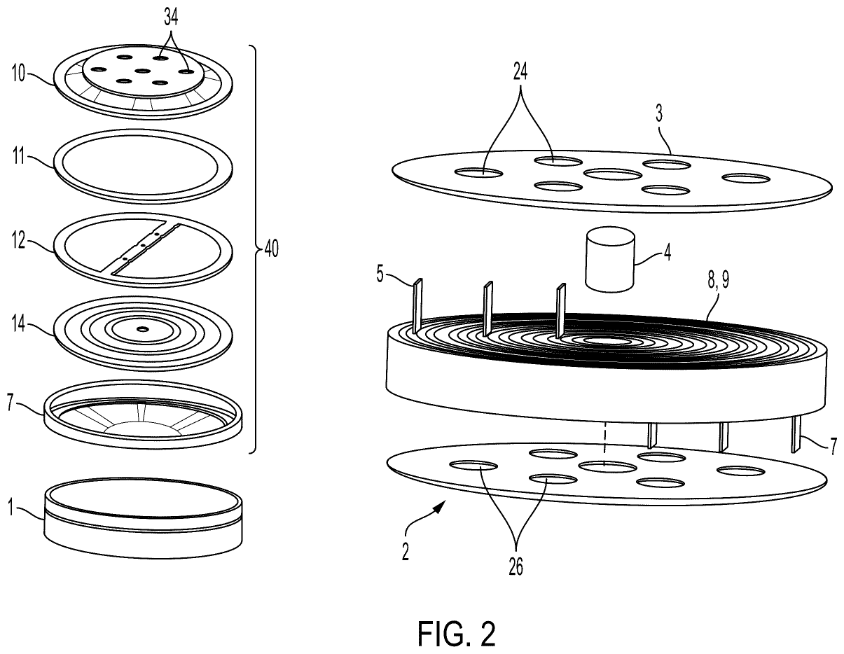

FIGS. 1 and 2 depict a cross-sectional view and an exploded perspective view, respectively, of a secondary battery according to the exemplary embodiment of the present invention. The battery is defined by a can 1 having a top open end or opening that is sized and configured for retaining an electrode assembly 15 and a cap assembly 40 within the can 1. As to the electrode assembly 15, two plate-shaped electrodes 8, 9 of opposing polarities (i.e., positive and negative polarity) are stacked and wound, resulting in a spiral rolled configuration often referred to as a “jelly-roll”-type electrode assembly 15. Separators (not shown in these views) are interposed in a conventional manner between the plate-shaped electrodes 8, 9 and/or placed beneath the electrodes to prevent short circuits between the electrodes 8, 9 during use.

The electrodes 8, 9 can be created in accordance with this exemplary embodiment by applying a slurry containing either positive or negative electrode active material onto collector plates. These collector plates are usually made of metal foil or metal mesh, such as aluminum or copper. The slurry is prepared by stirring together a particulate active material, a subsidiary conductor, a binder, and a plasticizer in a solvent. The solvent is then removed in a subsequent electrode formation process.

Non-coated portions are formed along the edges of each of the collector plates, creating a border in which the collectors themselves are not coated with the slurry. Multiple electrode tabs 5, 6 that are also made from an electrically conductive materials are connected or joined to these non-coating portions at the top and bottom of the electrode assembly 15. More specifically, a plurality of top or upper electrode tabs 5 extend upwardly toward the defined opening of the can 1, while another plurality of lower electrode tabs 6 extend downwardly toward a bottom surface of the can 1. In this embodiment, three (3) top electrode tabs 5 and bottom electrode tabs 6 are provided, but it will be understood that the overall number of electrode tabs 5, 6 can be suitably varied.

Multiple tabs 5, 6 are connected to the electrode assembly 15, preferably through integration into the rolling process of the “jelly roll type electrode at both the top and bottom of the electrode assembly 15. As previously noted, and in the herein described embodiment, three (3) top and bottom electrode tabs 5, 6 are positioned radially at different positions, relative to the center of the electrode assembly 15. The bottom surface of the electrode assembly 15 is covered with a lower insulating plate 2, prior to the insertion of the electrode assembly 15 into the interior of the can 1.

The can 1 according to this embodiment is a substantially cylindrical member that is preferably made from a metal, such as iron material (i.e., stainless steel), an aluminum alloy, or the like. The electrode assembly 15 is inserted into the can 1 through the defined top opening of the can 1.

As best shown in FIG. 1 and according to this exemplary embodiment, each of the bottom electrode tabs 6 are bent inwardly toward the center of the electrode assembly 15 so as to be parallel with one another and further to establish suitable electrical contact with the bottom surface of the can 1. The bottom electrode tabs 6 can either be in direct contact or spaced apart from the lower surface of the lower insulating plate 2.

Still referring to FIGS. 1 and 2, the electrode assembly 15 has a formed central hollow portion within the rolled spiral configuration, and within which a central pin 4 can be positioned. The lower insulating plate 2 has a through hole or opening in an area corresponding to the central hollow portion of the electrode assembly 15, as well as several additional holes 26 that are radially organized. A portion of the bottom electrode tabs 6 face one of the holes 26. As shown, the three (3) bottom electrode tabs 6 fold inwardly toward the center of the electrode assembly 15 and overlap one another. A welding rod (not shown) can be inserted into the center hollow portion of the electrode assembly 15 to weld the bottom electrode tabs 6 together on the bottom surface of the can 1 prior to insertion of the central pin 4. As a result, the can 1 has the same polarity as the bottom electrode tabs 6, effectively serving as an electrode terminal.

As noted, and according to this embodiment, a central pin 4 is inserted into the center hollow portion of the electrode assembly 15. When assembled, the central pin 4 prevents or at least substantially minimizes the can 1 from being deformed by external forces, acts as a passage for the removal of gas generated by the electrode assembly 15, and suppresses radial deformations of the electrode assembly 15 that may be caused by charging and/or discharging over time, thereby extending overall battery life.

After the bottom electrode tabs 6 are welded, an upper insulating plate 3 is positioned upon the top of the electrode assembly 15, with the upper electrode tabs 5 being inserted through holes 24 that are provided in the upper insulating plate 3. Each of the upper electrode tabs 5 can then be welded to the cap assembly 40 and more specifically to a multiple contact vent plate 14, as described in greater detail below.

The sidewall of the can 1 is then crimped to form a peripheral bead 13 to secure the electrode assembly 15 and the upper insulating plate 3. The formed bead 13 prevents the electrode assembly 15 from moving vertically within the can 1, even during external impacts, thereby ensuring a reliable electrical connection.

An electrolyte such as lithium hexafluorophosphate (LiPF₆) in a mixture with organic solvents like ethylene carbonate (EC) and dimethyl carbonate (DMC), lithium bis(trifluoromethanesulfonyl)imide (LiTFSI) with a mixture of carbonate solvents, lithium borate salts (e.g., LiBOB) in combination with various carbonate-based solvents, lithium perchlorate (LiClO₄) with compatible solvents, or lithium triflate (LiCF₃SO₃) in a blend of appropriate solvents is then injected into the can 1 to cover the electrode assembly 15. The electrolyte may be injected before the formation of the peripheral bead 13. An insulating gasket 7 is provided in the opening of the can 1, and the cap assembly 40 is coupled with the can 1 to seal it. The insulating gasket 7, which is made from an elastic material, is bent around the cap assembly 40. The purpose of the insulating gasket 7 is to insulate the cap assembly 40 from the can 1, which have different polarities, and further to assist in sealing the can 1.

The cap assembly 40 according to this exemplary embodiment further comprises the insulating gasket 7, as well as a vent plate 14 that is electrically connected to each of the multiple top electrode tabs 5, a multi-contact point current interrupt device (CID) 12 activated by operation of a defined vent 50, a positive temperature coefficient (PTC) thermistor 11, and a cap-up or cover 10 (electrode terminal). The components of the cap assembly 40 may be preassembled and then disposed on the insulating gasket 7 or the components may be sequentially stacked on the insulating gasket 7, as shown. The top opening of the can 1 is then crimped against the insulating gasket 7 to secure the cap assembly 40 and seal the can 1.

As shown, the cap-up 10, which is a cover member that is positioned on the PTC thermistor 11, with the CID 12 being positioned beneath the PTC thermistor 11, and the vent 14 being positioned beneath the CID 12. In other words, the vent plate 14, CID 12, PTC thermistor 11, and cap-up 10 are sequentially stacked upon one another, as best shown in FIGS. 1 and 2. In the present invention and owing to the wider area of the battery, the cap-up 10 (i.e., top external contact) of the battery is designed with several vent holes 34. This design serves two essential purposes: first, this design enhances the mechanical strength of the cap-up 10, and second, the design of the cap-up 10 facilitates improved thermal dissipation from the battery, contributing to its overall stability and performance. The vent holes 34 according to at least one embodiment are evenly spaced in a circular fashion and can be hexagonal in shape. As described in greater detail below and in use, when an internal pressure of the battery exceeds a predetermined level due to gas generated by the electrode assembly 15, the vent plate 14 is caused to shift from a first position to a second upward position that activates the CID 12 to interrupt current flow and release the gas via the vent holes 34 provided in the cap-up 10.

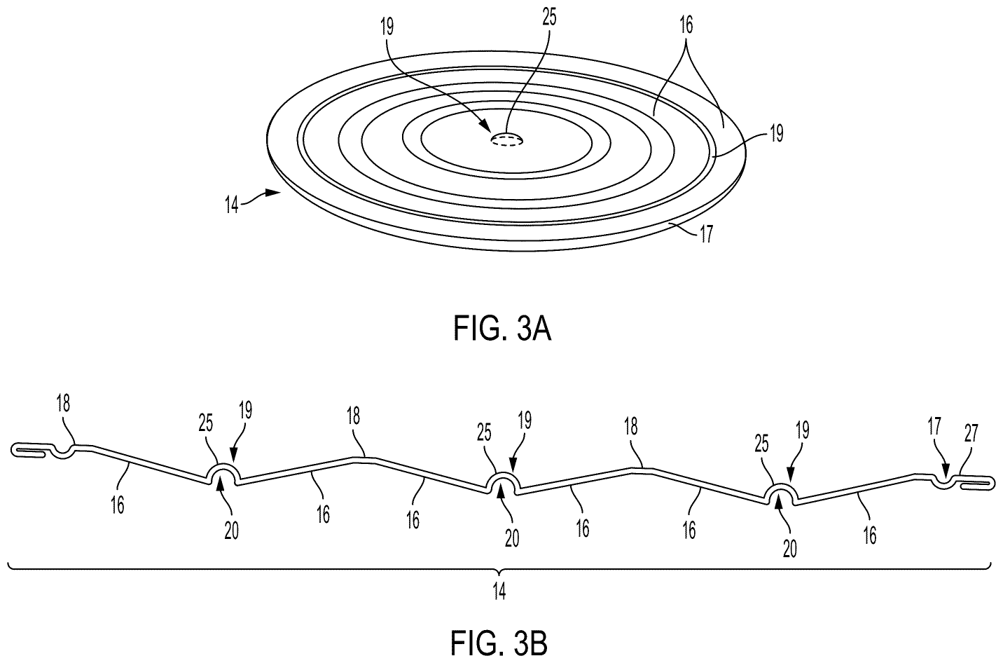

Further reference is herein made to FIGS. 1 and 2, as well as FIGS. 3(A) and 3(B) that depicts a perspective view and a cross-sectional view of the vent plate 14, respectively. The vent plate 14 according to this exemplary embodiment is defined by a disk-shaped component made from an iron material (e.g., stainless steel) or aluminum alloy, or the like having a plurality of electric connection portions 19 and a plurality of deformable sections 16 disposed along the span of the vent plate 14. In this specific embodiment, one of the electric connection portions 19 is formed at the center of the vent plate 14, with the remaining electric connection portions being radially disposed about the periphery of the plate 14. More specifically, the electric connection portions 19 are aligned positionally with the top electrode tabs 5, which are positioned beneath the vent plate 14, and as well as a corresponding number of multiple contact points 21, 22, 23 of the CID 12 as described in a later portion of this application.

According to this embodiment, each of the electric connection portions 19 are disposed between a pair of radially disposed deformable sections 16, with each deformable section downwardly extending from a raised section 18 of the vent plate 14. Each electric connecting portion is defined by a notch 20 on a lower side and a hemispherical or other suitably shaped protrusion 25 on an upper side, as shown. Each of the deformable sections 16 are shown to be of equal length according to this embodiment, but it will be understood that the lengths can be suitably varied for purposes of positioning the electric connection portions 19. A total of three (3) electric connection portions 19 are provided according to this specific embodiment, but as noted this parameter is scalable along with the number of top electrode tabs 5 and design of the CID 12. Each notch 20 extends downwardly toward the electrode assembly 15 and is fixedly secured to a corresponding electrode tab 5. As discussed herein, the multiple notch design enables multiple points of sensing overpressure and activation of the multi-point CID 12, whose design is described in greater detail below.

According to this exemplary embodiment, each protrusion 25 is substantially hemispherical in shape with the curved side of the protrusion 25 facing the CID 12. The vent plate 14 is also stably in contact with the CID 12, and has a v-shaped groove 27 at a peripheral outer edge 17 for improved response of the multipoint vent plate 14.

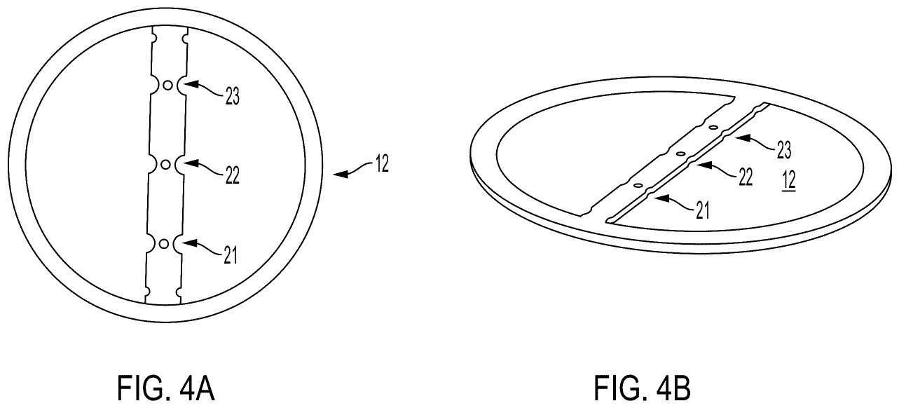

With reference to FIGS. 4(A) and 4(B), the multiple current interrupt device (CID) 12 comprises a ring-like member having a diametrically disposed strip that includes a plurality of contact points 21, 22, 23 that can be broken by the hemispherical protrusions 25 of the vent plate 14. These contact points 21, 22, 23, where the current can be interrupted, are positioned both at the center of the battery cell and radially outward along the single strip. When assembled, the positions of the contact points 21, 22, 23 for the current interrupt device 12 are positioned to match the protrusions 25 of each electric connecting portion 19 of the vent plate 14.

In use and while the internal pressure of the battery is below a predetermined level, the battery is as shown in FIG. 1, with the top electrode tabs 5 fixedly in contact with the electric connection portion 19 of the vent plate 14 and with the electric connection portions 19 well beneath and out of contact with the current interrupt device 12. The vent plate 14 is in a first position.

When the internal pressure of the secondary battery rises above the predetermined level, each of the deformable portions 16 are caused to move upwardly toward the CID 12, such that the electric connection portions are also deformed upwardly toward the CID 12 with the raised protrusions 25 of one or more of the electric connection portions 19 activating the CID 12 at their respective contact points 21, 22, 23, with the vent plate 14 having moved to a second upward position.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process, when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

This detailed description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

### PARTS LIST FOR FIGS. 1-4(B)

1 can
2 lower insulating plate
3 upper insulating plate
4 central pin
5 top or upper electrode tabs
6 bottom or lower electrode tabs
7 insulating gasket
8 electrode
9 electrode
10 cap up, cover, electrode terminal
11 PTC, thermistor
12 multipoint current interrupt device (CID)
13 peripheral bead
14 multi-electrical contact vent plate
15 electrode assembly
16 deformable portion, vent plate
17 outer peripheral edge, vent plate
18 raised portion, vent plate
19 electric connection portions
20 notch
21 contact point, CID
22 contact point, CID
23 contact point, CID
24 holes, upper insulating plate
25 protrusions, hemispherical
26 holes, lower insulating plate
27 v-shaped groove, vent plate
34 vent holes, cap-up
40 cap assembly

It will be understood that there are a number of varied modifications and variations of the present design, in accordance with the following claims.

1. A secondary battery comprising:
an electrode assembly including a positive electrode plate, a negative electrode plate, and a separator interposed between the positive and negative electrode plates, each of the electrode plates being disposed in a rolled spiral configuration;
a can sized and configured to house the electrode assembly; and
a cap assembly disposed above the electrode assembly within the can, the cap assembly comprising a vent plate configured to seal an opening of the can, wherein the vent plate includes a plurality of deformable sections and one or more electric connection portions, the secondary battery having an overall height dimension that is smaller than a corresponding width dimension.

2. The secondary battery according to claim 1, further comprising an insulating gasket interposed between the cap assembly and the can.

3. The secondary battery according to claim 1, wherein the deformable sections and electric connection portions are radially disposed on the vent plate.

4. The secondary battery according to claim 3, in which one electric connection portion is situated at the center of the vent plate and each of the electric connection portions are radially disposed between a pair of the deformable portions, each of the deformable portions downwardly extending from raised portions of the vent plate.

5. The secondary battery according to claim 1, wherein the cap assembly further comprises:
a current interrupt device (CID) positioned upon the vent plate;
a positive temperature coefficient (PTC) thermistor placed on the CID; and
a cap-up disposed upon the PTC thermistor.

6. The secondary battery according to claim 1, wherein the electrode assembly comprises a plurality of electrode tabs disposed at the top of the electrode assembly, and in which each electrode tab is fixedly secured to an electric connection portion of the vent plate.

7. The secondary battery according to claim 6, in which the CID includes a plurality of points of contact, each point of contact being positionally aligned with an electric connection portion of the vent plate.

8. The secondary battery according to claim 7, wherein each electric connection portion includes a notch on a lower side that is fixedly attached to an electrode tab of the electrode assembly and a protrusion on an upper side that is configured to contact one of the plurality of points of contact of the CID plate when an internal pressure of the battery exceeds a predetermined level and causes the deformable portions to deform toward the CID.

9. A cap assembly for a secondary battery, the cap assembly comprising:
a vent plate having a plurality of deformable sections and a plurality of electric connection portions, each electric connection portion being disposed between a pair of the deformable sections, the vent plate being configured for movement between a first position and a second position depending on an internal pressure of the secondary battery.

10. The cap assembly according to claim 9, further comprising a current interrupt device (CID) having multiple points of contact disposed above and positionally aligned with the plurality of electric connection portions of the vent plate.

11. The cap assembly according to claim 10, wherein the vent plate is moved to the second position in which at least one electric connection portion contacts and activates the CID by contacting at least one of the multiple points of contact when the internal pressure of the secondary battery exceeds a predetermined level.

12. The cap assembly according to claim 9, further comprising a top cap-up having a plurality of vent holes formed therein disposed.

13. The cap assembly according to claim 9, wherein the vent plate is disc-shaped wherein the plurality of deformable portions and electric connection portions are radially disposed about a center of the vent plate.

14. The cap assembly according to claim 13, wherein one of the electric connection portions is disposed at the center of the vent plate and each electric connection portion is disposed between a pair of the deformable sections, each of the deformable sections being downwardly extending toward an electrode assembly of the secondary battery.

15. The cap assembly according to claim 9, wherein the multiple points of contact of the current interrupt device (CID) contacts are positioned along a diametrical strip of the CID.

16. The cap assembly according to claim 9, further comprising:
a current interrupt device (CID) having a plurality of linearly disposed contact points positioned above the vent plate;
a positive temperature coefficient (PTC) thermistor; and
a top cap disposed over the PTC thermistor, the cover having a plurality of spaced vent holes disposed therein.

17. The cap assembly according to claim 9, in which each of plurality of electric connection portions are defined by a raised protrusion, wherein one of the electric connection portions is disposed in the center of the vent plate, and the remainder of the plurality of electric connection portions are disposed radially therefrom and in spaced relation.

18. The cap assembly according to claim 15, in which the multiple contact points of the CID include a contact point at the center of the CID in which the remainder of the contact points are disposed in radial positions therefrom.

19. An electrode assembly for a secondary battery having a low aspect ratio in which the height dimension of the secondary battery is smaller than a corresponding width dimension, the electrode assembly comprising:
a positive electrode plate;
a negative electrode plate, each of the positive and negative electrode plates being configured in a rolled spiral configuration; and
a plurality of electrical tabs formed on and extending from a top and bottom of the positive and negative electrodes to respective top and bottom contacts of the battery assembly.

20. The electrode assembly according to claim 19, wherein the bottom electrode tabs are bent inwardly onto one another.

21. The electrode assembly according to claim 19, in which the top and bottom electrode tabs are equal in number.

22. The electrode assembly according to claim 20, in which the bottom electrode tabs are configured to commonly contact a bottom of the battery.
